(19) United States
(12) Patent Application Publication
(10) Pub. No.: US 2008/0150239 A1
(43) Pub. Date: Jun. 26, 2008

(54) Seal containing a rigid core and at last one sealing barrier made of a flexible material

(76) Inventor: Ronan Bole, Bourgoin-Jallieo (FR)

Correspondence Address: HARNESS, DICKEY & PIERCE, P.L.C., P.O. BOX 828, BLOOMFIELD HILLS, MI, 48303, US

(21) Appl. No.: 11/184,057

(22) Filed: Jul. 18, 2005

(30) Foreign Application Priority Data
Jul. 19, 2004 (FR) 0451574

(51) Int. Cl. F02F 11/00

(52) U.S. Cl. 277/593

(57) ABSTRACT

The invention has for an object a seal containing a core of thickness I to which is connected at least one sealing barrier (16), characterized in that the core contains a stop (20) of thickness h greater than I as well as a raised shape (22) provided at the sealing barrier and having a height lower than that of the stop (20), and in that the sealing barrier consists of an element (24) of flexible material, particularly an elastomer, which is disposed at the raised shape (22), is con-nected to the face of the core (18), contains said raised shape and extends beyond said raised shape (22), the height of said element (24) made of flexible material being greater than that of the stop (20).

### CROSS-REFERENCE TO RELATED APPLICATIONS

This application claims the benefit of French patent application 0451574, filed Jul. 19, 2004. The disclosure of the above application is incorporated herein by reference.

### FIELD OF THE INVENTION

The present invention relates to a seal containing a rigid core and at least one sealing barrier made of a flexible material, particularly an elastomer.

### BACKGROUND OF THE INVENTION

As described in FR-2,768,211, a seal can contain a metallic core covered on each face by a layer of elastomer.

According to this document, the core contains elevations to promote bonding of the elastomeric layers to the core. The elevations also act as tightening stops and are as high as the elastomer layer.

To ensure sealing, the elastomer layers contain protruding threads that are capable of being compressed so as to form sealing barriers.

This type of seal is not completely satisfactory, however, and does not ensure optimum sealing because of a relatively low uncontrolled compression ratio of the elastomeric covering, particularly at the threads. This drawback becomes more pronounced the higher the pressure of the fluids to be sealed off inside present-day engines.

According to another variant, a seal can contain a metallic core covered on at least one of its faces by an elastomeric layer with protruding threads that can be compressed and form sealing barriers.

This variant is also not entirely satisfactory, however, because the mounting of the seal makes it necessary to control the tightening stresses to ensure that the elastomeric covering is not excessively compressed, thus losing its elastic properties.

### SUMMARY OF THE INVENTION

The purpose of the present invention therefore is to avoid the drawbacks of the prior art by providing a novel seal of simple design that ensures excellent sealing even at high pressures and which retains its sealing efficacy with time.

To this end, the present invention provides a seal containing a core of thickness I to which is connected at least one sealing barrier. The core contains a stop of thickness h greater than I, as well as a raised shape provided at the sealing barrier that is lower than the stop. The sealing barrier consists of an element of flexible material, particularly an elastomer, disposed at the raised shape, connected to the face of the core containing the raised shape and extending beyond the raised shape. The height of the element of flexible material is greater than that of the stop.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows the cross section of a simplified variant of an uncompressed seal;

FIG. 2 shows the cross section of another simplified variant of an uncompressed seal;

FIG. 3 shows the cross-section of a seal of FIG. 1 disposed between two sealing elements; and

FIG. 4 shows the cross-section an improved variant of an uncompressed seal.

### DETAILED DESCRIPTION OF THE PREFERRED EMBODIMENTS

The following description of the preferred embodiment(s) is merely exemplary in nature and is in no way intended to limit the invention, its application, or uses.

In the figures, reference numeral 10 refers to a seal capable of being disposed between two elements 12, 12′ to be sealed. The seal contains at least one opening 14 that is capable of cooperating with the conduits or openings provided at the elements to be sealed. Thus, the seal ensures tightness between the different openings 14, and between the openings 14 and the outside. The seal can be used for many applications. For example, the seal can be used as a head cylinder gasket, bearing gasket, distributor gasket, or a water pump gasket.

The seal 10 contains at least one continuous or discontinuous sealing barrier 16 appropriately disposed at the seal surface to limit propagation of a fluid. For example, the sealing barrier 16 can be provided a small distance from the peripheral edge of the seal 10, or around openings 14.

According to the present invention, the seal 10 contains a core 18 of thickness I with a stop 20 of thickness h greater than I, as well as a rib 22 at the sealing barrier 16 the raised shape of which is provided at the face of the seal containing stop 20. The core 18 is made of a material that is sufficiently rigid, at least at rib 22, and is profiled so as to limit the deformations of the rib 22 when the rib 22 is subjected to a stress.

The stop 20 can be obtained in different ways. For example, the stop 20 can be obtained by adding a shim, by deformation of the sheet metal (i.e., by bending), by punching, and the like.

The stop 20 is intended to limit compression of the seal 10 by imposing a lower limit onto the spacing between the elements to be sealed.

According to a preferred embodiment, the core 18 is made of sheet metal which is bent to obtain the stop 20, and is ribbed to obtain the rib 22.

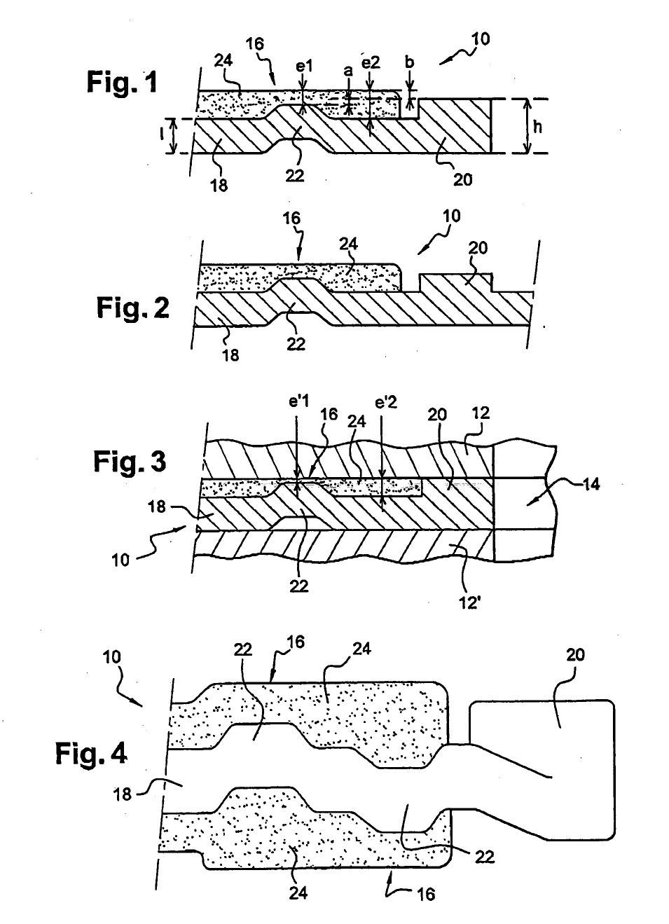

The stop 20 can be disposed at the peripheral edge of the seal 10 or of opening 14, as illustrated in FIGS. 1, 3 and 4, or in a manner as shown in FIG. 2. Depending on the case, the stop 20 can be raised on each side of the core 18, as illustrated in FIG. 4, or on only one side, as shown in FIGS. 2 and 3.

According to the present invention, the protruding part of rib 22 has a height which is less than that of the stop 20, the difference in height in FIG. 1 being indicated by a.

In addition, the sealing barrier 16 consists of an element 24 of flexible material, particularly an elastomer, which is disposed at rib 22, is connected to the face of core 18, contains the raised part of the rib 22 and extends on both sides of rib 22. Thus, element 24 has a thickness e1 opposite the raised part of rib 22, and a thickness e2 outside this zone.

According to the present invention, the height of element 24 made of flexible material is greater than that of the stop 20, the difference in height in FIG. 1 being indicated by b.

When seal 10 is compressed between two elements to be sealed 12, 12′, element 24 made of flexible material is compressed between the nearly rigid core 18 and one of elements 12 to be sealed. As can be seen, stop 20 limits the compression of element 24 made of flexible material and reduces the risk of deterioration thereof, particularly of its elastic properties with time.

When compressed, element 24 has a thickness e1′ opposite the raised part of rib 22 and a thickness e2′ outside this zone. Thus, opposite rib 22 the compression ratio e1′/e1 is greater than the compression ratio e2′/e2 of the zones located outside the rib.

This greater value of the compression ratio of the element made of flexible material makes it possible to form opposite rib 22 an effective sealing barrier capable of resisting high pressures.

More particularly, the seal of the present invention is adapted so as to ensure tight sealing between rigid elements subjected to high stresses for which the resistance to compression of the seal is given preference at the detriment of its flexibility.

According to one embodiment, the entire surface of seal 10 can be covered by an element made of flexible material. In this case, the covering can have different heights depending on the zone, a greater height being provided at the sealing barrier or sealing barriers.

According to another characteristic of the present invention, sealing barriers are provided on each face of the seal, with ribs 22 being oriented in opposite manner, as shown in FIG. 4. Advantageously, the sealing barriers of the upper and lower face are offset.

According to another characteristic of the present invention, the thickness e1 along the length of the sealing barrier can be variable so as to adjust the compression ratio depending on the tightening stresses, which at the contact surface of the seal are generally variable. This variation of thickness e1 can be achieved by adjusting the height of the rib and/or the height of the element made of flexible material.

For example, the core 18 is made of sheet metal with characteristics that depend on the sealing force required. Core 18 can be made of low-carbon steel (treated or not) or of stainless steel. For example, the mechanical strength of the core 18 can be in the range from 500 to 1300 Mpa. For use in particularly aggressive environments, the core will advantageously be protected by an anticorrosive, for example zinc-based, coating.

Preferably, the flexible material must show high heat resistance and a high resistance to coolants and oils, and it must have a compression set of less than 50%. For example, elastomers from the families of NBR, SBR, EPDM, MVQ and FPM can be used.

The thickness I of the core 18 varies from about 0.1 to 1 mm.

The thickness h of the stop 20 varies from about 0.15 to 1.2 mm.

The difference in height a between the raised part of the rib 22 and the support plane of the stop 20 is greater than or equal to about 30% of the thickness of element 24.

The difference in height b between the element made of flexible material and the support plane of the stop 20 will is of the order of 10 to 70% of the thickness e1 of element 24.

According to a preferred embodiment, sheet metal is bent and ribbed in an appropriate manner to form core 18. After that, liquid elastomer is injected into a mold having the shape of a sealing barrier and containing at least a part of core 18. Following curing of the elastomer, the core 18 is cut so as to form adequate openings and orifices as well as the periphery of the seal 10.

By injecting the elastomer after the core 18 has been placed into the mold, the risks of deterioration of the elastomeric covering are limited.

According to a variant, rib 22 can be replaced with other raised shapes provided at the core 18. The shapes permit reduction of the thickness of the element made of flexible material and increase the compression ratio when the seal 10 is installed. Such a raised shape can be obtained by bending and/or cutting the core 18, or by adding a shim.

The description of the invention is merely exemplary in nature and, thus, variations that do not depart from the gist of the invention are intended to be within the scope of the invention. Such variations are not to be regarded as a departure from the spirit and scope of the invention.

1. A seal comprising:
a core having a thickness I; and
at least one sealing barrier, the core connected to the at least one sealing barrier,
wherein the core contains a stop having a thickness h that is greater than the thickness I and a raised shape provided at the sealing barrier, the shape having a height lower than a height of the stop; and
the sealing barrier consists of an element made of a flexible material, which is disposed at the raised shape, the element being connected to a face of the core containing the raised shape and extending beyond the raised shape, a height of the element being greater than a height of the stop.

2. The seal according to claim 1, wherein the raised shape is a protruding part of a rib.

3. The seal according to claim 1, wherein the core includes another face, another sealing barrier being disposed at the another face.

4. The seal according to claim 1, wherein the thickness of the element made of flexible material opposite the raised shape is variable.

5. The seal according to, wherein the difference in height between the raised shape and the stop is greater than or equal to about 30% of the thickness of the element opposite the raised shape.

6. The seal according to, the difference in height between the element made of flexible material opposite the raised shape and the stop is of the order of 10 to 70% of the thickness of the element opposite the raised shape.

7. A seal comprising:
a core member including a protruding portion and a stop member; and
a sealing barrier disposed at a surface of said core member including said protruding portion,
wherein a height of the stop member is greater than a height of the protruding portion.

8. The seal according to claim 7, wherein a height of the sealing barrier is greater than a height of the stop member.

9. The seal according to claim 7, wherein a thickness of the sealing barrier at said protruding portion is smaller than a thickness of the sealing barrier at portions of the core member adjacent said protruding portion.

10. The seal according to claim 7, wherein the core member is comprised of sheet metal.

11. The seal according to claim 7, further comprising a second protruding portion, said second protruding portion protruding from a second surface of the core member opposite said surface of said core member including said protruding portion.

12. The seal according to claim 11, further comprising a second sealing barrier, said second sealing barrier disposed at said second surface of said core member.

13. The seal according to claim 7, wherein a mechanical strength of said core is in the range of 500 to 1300 Mpa.

14. The seal according to claim 7, wherein said sealing barrier is selected from the group consisting of NBR, SBR, EPDM, MVQ, and FPM.
